(19) United States
(12) Patent Application Publication
(10) Pub. No.: US 2024/0047874 A1
(43) Pub. Date: Feb. 8, 2024

(54) DUAL-BAND PATCH ANTENNA FOR ANGLE-OF-ARRIVAL ANALYSIS

(71) Applicant: GOOGLE LLC, Mountain View, CA (US)

(72) Inventors: Seckin Sahin, Santa Clara, CA (US); Ming Zheng, Santa Clara, CA (US)

(21) Appl. No.: 18/266,490

(22) PCT Filed: Dec. 11, 2020
(86) PCT No.: PCT/US20/64566

§ 371 Date: Jun. 9, 2023

(51) Int. Cl. H01Q 5/30; H01Q 9/04; H01Q 21/08; H01Q 3/26; H01Q 21/24

(52) U.S. Cl. CPC H01Q 5/30; H01Q 9/045; H01Q 21/08; H01Q 3/2623; H01Q 21/24

(57) ABSTRACT

A dual-mode antenna array receives RF signaling for AoA analysis, and includes a substrate, a ground plane disposed at a first side and a pair of radiating elements disposed at a second side. Each radiating element of the pair includes conductive material arranged in a modified rectangular shape having a first slot at a first side, a second slot at a second side, a third slot at a third side, and a fourth slot at a fourth side. The antenna array further includes a feed probe disposed adjacent to the pair of radiating elements and a pair of feedlines, each feedline conductively connected, at a first end, to the feed probe and connected, at a second end, to each of a first feed point and a second feed point of a corresponding radiating element.

### BACKGROUND

Wireless systems frequently employ techniques based on received radio frequency (RF) signal analysis to determine the location of one wireless device relative to another wireless device. This location information may be useful for beamforming techniques, for device authentication or user authentication or other security considerations, and the like. Such techniques typically rely on two analyses: Time of Flight (ToF) analysis and Angle-of-Arrival (AoA) analysis. ToF analysis utilizes a measurement of the elapsed time between transmission of a RF signal and receipt of a reply RF signal to determine the distance between the initiating device and the responding device. AoA analysis estimates the direction by which an incoming RF signal is received to determine the angular position of the transmitting device relative to the receiving device. With distance and angular position known, the location of one wireless device relative to another can be ascertained.

Ultra-Wide Band (UWB)-based RF technologies often are well-suited for use in providing AoA analysis in wireless systems having relatively close proximity between wireless devices, that is, within personal area network (PAN) ranges. UWB signaling is relatively efficient as it typically relies on pulsed signals of relatively short durations, and because such signaling is transmitted over a relatively wide bandwidth (e.g., 500 megahertz (MHz)), UWB signaling can share spectrum with other wireless devices. In a typical approach utilizing UWB signaling for AoA analysis, the transmitting device employs UWB signaling in one or more separate bands that are orthogonally polarized relative to each other (for example, one UWB band polarized in the horizontal direction and one UWB band polarized in the vertical direction). The receiving device employs an AoA antenna array to concurrently receive the UWB signaling in each band utilized, and from the one or more received RF signals determine one or more AoA parameters.

To illustrate, FIG. 1 depicts a typical Time Difference of Flight (TDOF)-based AoA analysis using an antenna array 100 having two identical rectangular patch antennas 101, 102 offset by a distance “d”. An incoming RF signal 104 arriving at a non-zero angle θ relative to the boresight (the Z-axis in this case) of the antenna array 100 is received at each of the rectangular patch antennas 101, 102. However, because the RF signal 104 is received at the illustrated non-zero angle, the distance the RF signal 104 travels to reach the patch antenna 101 is greater than the distance traveled to reach the patch antenna 102, with this distance being equal to k*d*sin(θ), where k represents the wavenumber of the RF signal 104 in the corresponding medium. As such, there is a time offset between when the RF signal 104 is received at the patch antenna 102 and when the RF signal 104 is received at the patch antenna 101. This time offset introduces an AoA-dependent phase difference between the different representations of the RF signal 104 as received at the antennas 101, 102, and this phase difference thus can be used to estimate the AoA of the RF signal 104.

As illustrated by chart 200 of FIG. 2, the AoA-dependent phase difference of an AoA antenna array is ideally represented as k*d*sin(θ), which would permit a system implementing such an AoA antenna array to determine the angle-of-arrival θ of the incoming RF signal based on the particular phase difference between the two received signals and the expression k*d*sin(θ). For accurate angle of arrival calculations, the phase difference between the two AoA signals ideally would only come from the path differences. This condition can be substantially met when the two AoA antennas have the identical phase pattern (which eliminates any structure-related phase difference between two measured AoA signals) and when the two AoA antennas have the uniform amplitude pattern (so that the antenna works for all angles and does not have a null at one or more angles).

Patch antennas in theory are well-suited to meet the above-identified conditions. They often have substantially uniform amplitude pattern and phase pattern. However, in practice, conventional AoA antenna arrays do not exhibit this ideal phase relationship as a result of, among other reasons, asymmetry between the antennas due to mismatches in the feed structures between the two antennas. Moreover, the increasing miniaturization of user devices has led to device form factors that are often unable to practicably accommodate the relatively-large dimensions of conventional UWB-based AoA antenna arrays, which is a result of one or both of their relatively large floorplan areas due to the dimensions of the conventional rectangular patch antennas they employ or their relatively thick profiles due to one or both of the utilization of three-dimensional antenna structures or the relatively-thick substrates required to implement conventional patch antenna shapes.

### SUMMARY OF EMBODIMENTS

A dual-mode antenna array configured to receive radio frequency (RF) signaling for angle-of-arrival (AoA) analysis is provided, the antenna array comprising: a substrate; a ground plane disposed at a first side of the substrate; and a pair of radiating elements disposed at a second side of the substrate opposite the first side and separated by a lateral distance, each radiating element of the pair comprising: conductive material arranged in a rectangular shape having a first slot at a first side, a second slot at a second side opposite the first side, a third slot at a third side, and a fourth slot at a fourth side opposite the third side such that by arranging the first, second, third and fourth slot a modified rectangular shape is obtained. The first, second, third and/or fourth side may extend essentially linearly.

The first slot and second slot each may have a depth such that a length of a perimeter of the modified rectangular shape at each of the first side and the second side is at least equal to a half-wavelength of a center frequency of a first band in the received RF signaling; and/or the third slot and fourth slot each has a depth such that a length of the perimeter of the modified rectangular shape at each of the third side and the fourth side is at least equal to a half-wavelength of a center frequency of a second band in the received RF signaling, wherein, for example, the second band orthogonally is polarized relative to the first band.

Further, the dual-mode antenna array may comprise a feed probe disposed at the second side of the substrate and adjacent to the pair of radiating elements; a first microstrip feedline conductively connected, at a first end, to the feed probe and connected, at a second end, to a first radiating element of the pair at each of a first feed point and a second feed point of the first radiating element; and/or a second microstrip feedline conductively connected, at a first end, to the feed probe and conductively connected, at a second end, to a second radiating element of the pair at each of a third feed point and a fourth feed point of the second radiating element, wherein the third and fourth feed points, for example, have locations on the second radiating element that correspond to locations of the first and second feed points, respectively, of the first radiating element.

Moreover, a length of the first microstrip feedline between the feed probe and the first feed point may be substantially equal to a length of the second feedline between the feed probe and the third feed point; and/or a length of the first microstrip feedline between the feed probe and the second feed point may be substantially equal to a length of the second feedline between the feed probe and the fourth feed point.

The first, second, third, and fourth feed points may have substantially equal impedances.

The feed probe may be disposed between the first radiating element and the second radiating element.

The feed probe may be disposed adjacent to collinear sides of the first radiating element and the second radiating element.

The first microstrip feedline may be conductively coupled to the first feed point and second feed point using conductive vias; and/or the second microstrip feedline may be conductively coupled to the third feed point and fourth feed point using conductive vias.

For example, the lateral distance is not greater than half of the wavelength of the higher of the center frequency of the first band and the center frequency of the second band.

Further, a length of each of the first side and the second side may be less than the wavelength of the center frequency of the first band in a material of the substrate; and/or a length of each of the third side and the fourth side may be less than the wavelength of the center frequency of the second band in a material of the substrate. The length of the first and the second side may be defined by the distance between the third and the fourth side, while the length of the third and the fourth side may be defined by the distance between the first and the second side.

The center frequency of the first band may be 6.5 gigahertz (GHz); and/or the center frequency of the second band may be 8 GHz; and/or the length of each of the first side and the second side may be less than 13.3 millimeters (rnm), and/or the length of each of the third side and the fourth side may be less than 10.8 mm.

Moreover, the center frequency of the first band may be 6.5 gigahertz (GHz); and/or the center frequency of the second band may be 8 GHz; and/or the depth of each of the first slot and the second slot is approximately 1.05 millimeters (mm) and/or the width of each of the first slot and the second slot is approximately 1.0 mm; and/or the depth of each of the third slot and the fourth slot is approximately 3.45 mm and/or the width of each of the third slot and the fourth slot is approximately 1.0 mm; and/or the length of each of the first side and the second side is approximately 10.1 mm; and/or the length of each of the third side and the fourth side is approximately 8.2 mm.

For example, the thickness of the substrate between the first side and the opposing second side is not greater than 0.4 mm.

In another aspect, a dual-mode antenna array configured to receive radio frequency (RF) signaling for angle-of-arrival (AoA) analysis, in particular as described above, is provided the antenna array comprising a feed probe disposed at a first surface of a substrate; first and second radiating elements disposed at the first surface of the substrate adjacent to the feed probe; and a feed structure electrically coupling the first and second radiating elements to the feed probe, the feed structure comprising: a first microstrip feedline connected to the feed probe at a first end and connected to first and second feed points of the first radiating element at a second end; and a second microstrip feedline connected to the feed probe at a first end and connected to third and fourth feed points of the second radiating element at a second end; and locations of the first and second feed points on the first radiating element being the same as locations of third and fourth feed points, respectively, on the second radiating element (for example, on conductive material arranged in a rectangular shape of the radiating element as described above). The locations of the feed points may be defined relative to corresponding reference points of the radiating elements (e.g. a corner or another point of the perimeter of the radiating elements, in particular of the rectangular shape).

The first microstrip feedline and the second microstrip feedline may have substantially equal lengths.

Moreover, a length of the first microstrip feedline between the feed probe and the first feed point may substantially equal to a length of the second feedline between the feed probe and the third feed point; and/or a length of the first microstrip feedline between the feed probe and the second feed point may be substantially equal to a length of the second feedline between the feed probe and the fourth feed point.

Further, the first, second, third, and fourth feed points may have substantially equal impedances.

The feed probe may be disposed between the first radiating element and the second radiating element.

The feed probe may be disposed adjacent to collinear sides of the first radiating element and the second radiating element.

The first microstrip feedline may be conductively coupled to the first feed point and second feed point using conductive vias; and/or the second microstrip feedline may be conductively coupled to the third feed point and fourth feed point using conductive vias.

Moreover, an electronic device is provided comprising a dual-mode antenna array as described above.

The electronic device may comprise an RF receiver conductively coupled to the feed probe and configured to process the RF signaling received at the dual-band antenna array; and/or a baseband processor coupled to the RF receiver and configured to determine one or more AoA parameters from the RF signaling received at the dual-band antenna array and processed by the RF receiver.

Further, a method of operating the electronic device is provided, comprising receiving a first representation of a first RF signal of the RF signaling at a first radiating element of the pair and receiving a second representation of the first RF signal of the RF signaling at a second radiating element of the pair; and determining a first AoA parameter based on a phase difference between the first representation and the second representation of the first RF signal.

The method may comprise receiving a first representation of a second RF signal of the RF signaling at the first radiating element and receiving a second representation of the second RF signal of the RF signaling at the second radiating element; and determining a second AoA parameter based on a phase difference between the first representation and the second representation of the second RF signal.

### BRIEF DESCRIPTION OF THE DRAWINGS

The present disclosure is understood, and its numerous features and advantages made apparent to those skilled in the art by referencing the accompanying drawings. The use of the same reference symbols in different drawings indicates similar or identical items.

FIG. 1 is a block diagram illustrating a typical Time Delay of Flight (TDOF) approach for calculating Angle-of-Arrival (AoA) of an incoming radio frequency (RF) signal.

FIG. 2 is a chart illustrating an ideal relationship between phase difference of received representations of an RF signal versus AoA of the RF signal.

FIG. 3 is a diagram illustrating a top view of a dual-mode AoA antenna array in accordance with some embodiments.

FIG. 4 is a diagram illustrating a cross-section view of the dual-mode AoA antenna array of FIG. 3 in accordance with some embodiments.

FIG. 5 is a diagram illustrating a top view of an alternative implementation of the dual-mode AoA antenna utilizing a side-adjacent feed probe in accordance with some embodiments.

FIG. 6 is a diagram illustrating phase pattern differences for two modes for an example simulated implementation of a dual-mode AoA antenna array in accordance with some embodiments.

FIG. 7 is a diagram illustrating a wireless system having an electronic device utilizing a dual-mode AoA antenna array for performing AoA analysis of a received RF signal in accordance with some embodiments.

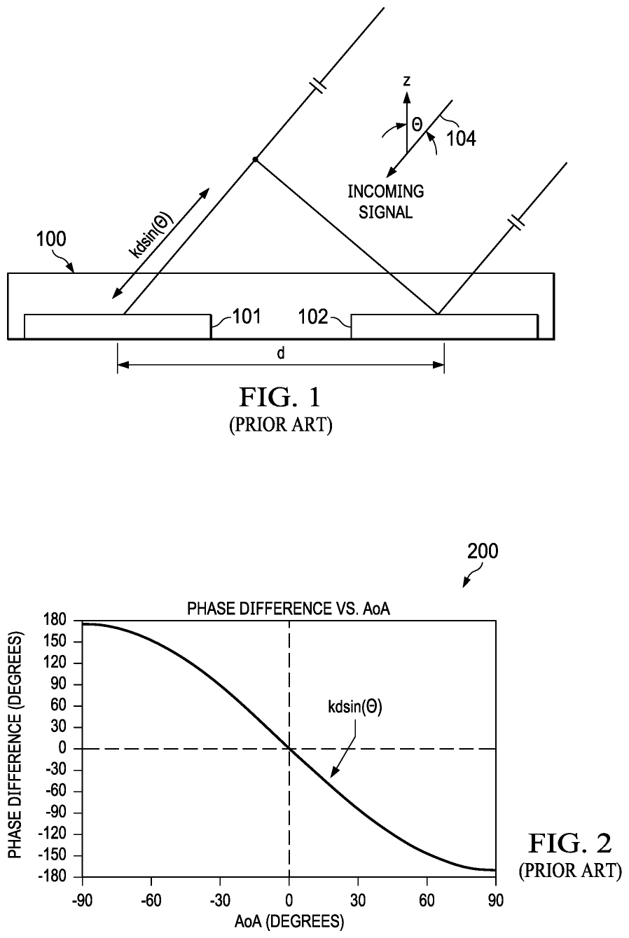

### DETAILED DESCRIPTION

Many conventional AoA antenna arrays configured to operate high-frequency, high-bandwidth signaling and which exhibit sufficient linearity in their phase differences often have dimensions that render them impracticable for integration in many compact electronic devices. In contrast, described herein are embodiments of a dual-band AoA antenna array that employs dual antennas with a radiating patch shape that facilitates compact implementation in any of a variety of electronic devices. Further, in some embodiments, the dual-band AoA antenna further employs symmetric feed structures that maintain substantial symmetry between the antennas of the antenna array, and thereby facilitating a more linear AoA-dependent phase difference pattern between the antennas of the antenna array.

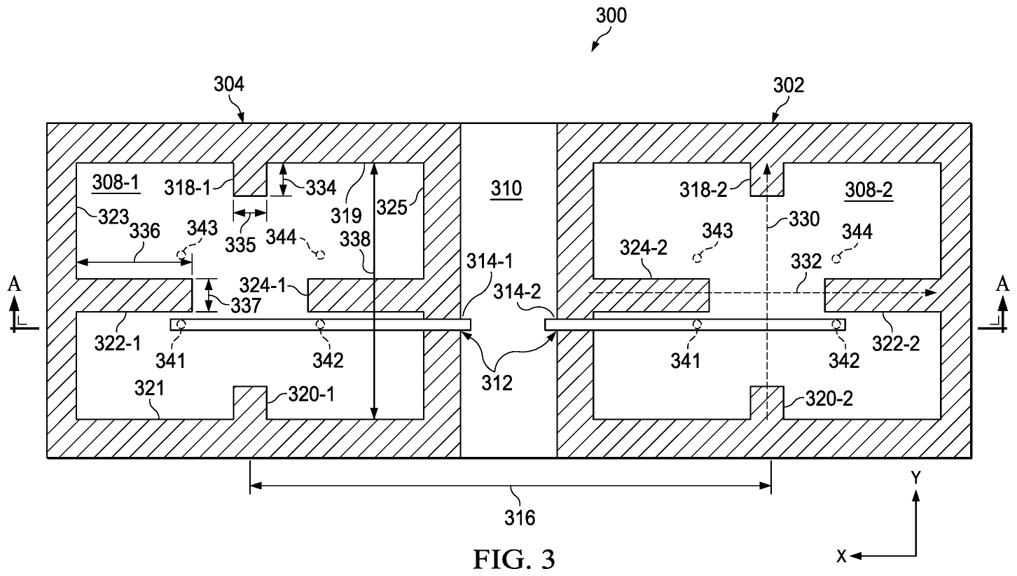

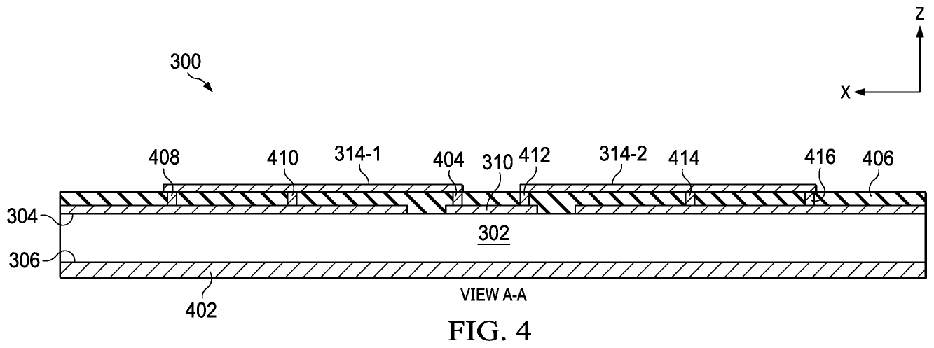

FIGS. 3 and 4 together illustrate a dual-mode antenna array 300 configured for facilitating AoA analysis of incoming RF signals in accordance with some embodiments. FIG. 3 depicts a top view of the dual-mode antenna array 300 in the X-Y plane and FIG. 4 depicts a cross-section view along line A-A of the dual-mode antenna array 300 in the X-Z plane. Note that the dimensions of some of the components of the antenna array 300 along the Z-axis in the cross-section view of FIG. 4 are exaggerated to facilitate their depiction and understanding. As shown, the dual-mode antenna array 300 (hereinafter, “antenna array 300” for purposes of brevity) comprises a dielectric substrate 302 having a first major surface 304 and an opposing second major surface 306. The dielectric substrate 302 can implemented as, for example, a rigid or flexible printed circuit board (PBC), and may be composed of any of a variety or combination of dielectric materials, such as liquid crystal polymer (LCP), polytetrafluoroethylene (PTFE), various ceramics, various low-loss plastics, glass-reinforced epoxy laminate (e.g., FR-4), and the like.

The antenna array 300 further includes a ground plane 402 (FIG. 4) disposed at the major surface 306 of the substrate 302, as well as a pair of radiating elements 308, individually identified herein as radiating element 308-1 and radiating element 308-2, and a feed probe 310 disposed at the opposing major surface 304. A feed structure 312 includes microstrip feedlines 314-1 and 314-2 that electrically couple the feed probe 310 to the radiating elements 308-1 and 308-2, respectively. The ground plane 402, radiating elements 308, feed probe 310, and feed structure 312 are composed of one or more conductive materials, such as copper (Cu), gold (Au), silver (Ag), aluminum (Al) or alloys thereof, and each component may be composed of the same or different conductive materials or combinations thereof. These structures can be disposed at the corresponding surface of the substrate 302 in any of a variety of ways, including through deposition, etching, adherence of a film or foil, or a combination thereof.

As described in greater detail below, radiating elements 308-1, 308-2 are configured to operate as a pair of receiver antennas to receive RF signaling, and from the phase difference between a representation of the RF signaling received at the radiating element 308-1 and a representation of the RF signaling received at the radiating element 308-2, determine an angle-of-arrival (AoA) of the RF signaling relative to a boresight or other reference axis of the antenna array 300. Accordingly, to facilitate efficient operation in this regard, the radiating elements 308-1, 308-2 in some embodiments are laterally separated (along the X-axis) by a distance 316 (center to center) that is not greater than one-half of the wavelength λ in air of the highest center frequency for which the antenna array 300 is configured to support (that is, distance 316<=λ). For example, for a highest center of frequency of 8 GHz, the center-to-center distance between the radiating elements 308-1, 308-2 could be set to 18 mm, which is close to, but does not exceed, the 18.75 mm half-wavelength of a 8 GHz RF signal. By configuring the distance 316 to close to the half-wavelength without exceeding the half-wavelength distance, the radiating elements 308-1, 308-2 can more readily and accurately measure phase differences between ±180 degrees (and thus increasing robustness) while mitigating or eliminating the potential for phase wrappings at higher frequencies.

As also described in greater detail below, in at least some embodiments the radiating elements 308-1, 308-2 are configured to support dual-mode operation and thus provide polarization diversity, such that the radiating elements 308-1, 308-2 can be implemented to efficiently receive first RF signaling having a first center frequency and a first polarization and receive second RF signaling having a second center frequency and a second polarization that is orthogonal to the first polarization. To illustrate by way of example, the antenna array 300 can be configured to support operation for both UWB channel 5 (center frequency 6.5 GHz, 500 MHz bandwidth, vertical polarization) and UWB channel 9 (center frequency of 8 GHz, 500 MHz bandwidth, horizontal polarization). For ease of description, this example UWB Channel 5/Channel 9 configuration is referenced frequently below, but it will be understood that this configuration is but one example and the antenna array 300 can be configured to support different combinations of orthogonally polarized UWB channels, as well as to support dual-mode operation in other high frequency bands/channels unrelated to UWB, using the guidelines provided herein. Accordingly, reference to UWB or to the particular UWB Channel 5/Channel 9 implementation described above shall be understood to equally apply to other frequency bands/channels or to other RF technologies entirely unless otherwise noted.

In order to efficiently operate in support of a TDOF-based AoA analysis of received RF signaling, the radiating elements 308-1, 308-2, in at least one embodiment, are configured to be substantially identical, that is, having approximately equal dimensions and composition, and the feed structure 312 is configured to be substantially symmetric with respect to the feed probe 310 and the radiating elements 308-1, 308-2. Implementing such symmetry, subject to the practical limits of the processes employed to design and manufacture the antenna array 300, mitigates any phase pattern differences that otherwise would result between the radiating elements 308-1, 308-2 in receiving an incoming RF signal, and thus leading to a more linear and invertible relationship between AoA and phase difference patterns for TDOF representations of the incoming RF signal.

In order to efficiently provide dual-mode operation for orthogonally-polarized RF signals, the radiating elements 308-1, 308-2 employ a generally rectangular patch shape so as to provide a half-wavelength current path for a vertically-polarized RF signal while also providing a half-wavelength current path for a horizontally-polarized RF signal. However, in some implementations, use of an unmodified rectangular area for each radiating element would result in a relatively-large floorplan area for each radiating element, and thus result in an overall floorplan area for the antenna array 300 that is too large for practicable implementation in many compact electronic devices, such as smart watches, key fobs, cellular phones, RF modules of vehicles, etc. Accordingly, in some embodiments, the conductive layers implementing the radiating elements 308-1, 308-2 each is formed to have a modified rectangular patch shape, with each side of the resulting generally rectangular area of conductive material having at least one slot extending toward the center of the radiating element and being substantially devoid of conductive material. To illustrate, in the embodiment depicted in FIG. 3, the radiating element 308-1 is composed of copper or other conductive material arranged in a modified rectangular shape, with a slot 318-1 on side 319, a slot 320-1 on opposing side 321, a slot 322-1 on side 323, and a slot 324-1 on opposing side 325. The slots 318-1 and 320-1 extend toward the center of the modified rectangular shape from the corresponding patch sides 321, 323 in the Y-direction, while the slots 322-1 and 324-1 extend toward the center of the modified rectangular shape from the corresponding patch sides 323, 325. In some embodiments, opposing slots are centered on their corresponding sides and have the substantially same dimensions (depth and width) for purposes of symmetry, but in other embodiments opposing slots may have different dimensions, may be offset relative to the center of the corresponding side, or a combination thereof. Consistent with implementing the radiating elements 308 so as to be substantially identical in dimension and composition, the radiating element 308-2 likewise has slots 318-2, 320-2, 322-2, and 324-2 at its corresponding sides with positions and dimensions corresponding to the positions and dimensions of slots 318-1, 320-1, 322-1, and 324-1, respectively.

The presence of a slot in a side of an otherwise rectangular shape of a patch radiating element increases the effective length of the perimeter at that side of the patch radiating element, and thus increases the current path “length” of that side so as to be greater than the straight-line length of that side for purposes of resonance for a received RF signal polarized in a direction parallel to that side. This in turn allows the overall, or straight-line, dimension of that side of the rectangular shape to be decreased below the half-wavelength of the received RF signal for the composition of the underlying substrate 302, while still providing a half-wavelength current path. To illustrate, RF signals in UWB channel 5, which have a center frequency of 6.5 GHz and have a polarization orientation 330 parallel to the Y-axis in the orientation depicted in FIG. 3, have a half-wavelength of 13.3 mm in an LCP substrate, and thus would require the opposing sides of a regular rectangular patch radiating element to be at least 13.3 mm long in the Y-direction in order to provide a half-wavelength current path. Similarly, RF signals in UWB channel 9, which have a center frequency of 8 GHz and a polarization orientation 332 parallel to the X-axis in this illustrated orientation, have a half-wavelength of 10.8 mm in an LCP substrate, and thus would require the opposing sides of the regular rectangular patch radiating element to be at least 10.8 mm long in the X-direction in order to provide a half-wavelength current path. That is, an unmodified rectangular radiating element would need to be 13.3 mm long in the Y-direction and 10.8 mm wide in the X-direction in order to provide dual-mode resonance for both UWB Channel 5 and UWB Channel 9 when using an LCP substrate.

However, if, for example, the antenna array 300 were to employ the same LCP substrate and the radiating elements 308-1, 308-2 with slots 318-1, 318-2, 320-1, and 320-2 each having a depth (dimension 334) of 1.05 mm and a width (dimension 335) of 1.0 mm, and with slots 322-1, 322-2, 324-1, and 324-2 each having a depth (dimension 336) of 3.45 mm and a width (dimension 337) of 1.0 mm, then the overall length (dimension 338) in the Y-direction and the overall length (dimension 339) in the X-direction of each radiating element 308-1, 308-2 can be reduced to 8.2 mm and 10.1 mm, respectively, while continuing to provide an effective perimeter lengths, and thus effective current path lengths, of at least 13.3 mm in the Y-direction and 10.8 mm in the X-direction. That is, the presence and dimensions of the slots in the radiating elements 308-1, 308-2 allow the radiating elements 308-1, 308-2 to have overall dimensions (338, 339) less than the corresponding half-wavelengths of the intended resonating frequencies in the underlying substrate material while providing effective side perimeter lengths, and thus corresponding current path lengths, at least equal to the half-wavelengths of the intended resonating frequencies, and thus allowing the radiating elements 108-1, 108-2 to resonate efficiently at the identified center frequencies of the channels the dual-mode antenna array 300 is designed to support. That is, by introducing slots with the dimensions identified above, in this example the overall dimensions of the radiating elements 308 can be reduced from 13.3 mm×10.8 mm (as required using an unmodified rectangular shape) to 10.3 mm×8.2 mm (using a modified rectangular shape with the slots described above). As such, with smaller floorplan areas required for the radiating elements 308-1, 308-2, the overall floorplan area of the antenna array 300 likewise can be reduced, and thus allowing the resulting antenna array 300 to be more readily implemented in smaller or more compact electronic devices.

From the above, it will be appreciated that an increase in the depths of opposing slots permits a proportional decrease in the overall length of the sides of the radiating element 308 implementing the opposing slots. However, it will also be appreciated that the greater the reduction in the overall length of a side of the radiating element 308, the less efficient the resonance of the radiating element 308 typically will be for the target RF signal polarized in the corresponding direction. Thus, in actual implementation the selection of the dimensions of the radiating elements 308-1, 308-2 and the slots they contain may involve identifying a suitable trade-off between floorplan area and overall antenna efficiency. To illustrate, in some instances, the maximum floorplan area may be fixed, and the maximum overall dimensions of each radiating element 308 likewise fixed (particularly given the near half-wavelength separation (distance 316) maintained between the radiating elements 308-1, 308-2), and thus the dimensions of the slots selected in view of these fixed overall dimensions. In other instances, a minimum efficiency for each mode may be specified, and the overall dimensions and slot dimensions selected based on these parameters though, for example, iterative simulation and evaluation processes.

As with many patch antennas, the centers of the radiating elements 308-1, 308-2 are not used as the feed points for connecting the radiating elements 308-1, 308-2 to the feed probe 310 due to an insufficient impedance presented at the center point. Rather, the candidates for feed point locations in a patch antenna are those points that present an impedance suitable for impedance matching with the other components, which often means approximately a 50 ohm (Ω) impedance. Due to the four-lobe shape that is symmetric about the X-axis and the Y-axis resulting from the implementation of the opposing slots at each of the four sides, each radiating element 308-1, 308-2 has four candidate feed points that provide suitable impedances, illustrated as candidate feed points 341, 342, 343, and 344.

In a typical conventional feed approach, the same single feed point on each radiating element 308 would be connected via a corresponding microstrip feedline to the feed probe 310. For example, a first microstrip feedline would connect feed point 341 of radiating element 308-1 to the feed probe 310, and second microstrip feedline would connect feed point 341 of radiating element 308-2 to the feed probe 310. However, because of the position of the feed probe 310 between the radiating elements 308-1, 308-2 in this example embodiment, the feed point 341 of radiating element 308-2 is closer to the feed probe 310 than the feed point 341 of radiating element 308-1. As a result, the first microstrip line would be substantially longer than the second microstrip line, and this difference or asymmetry in transmission line lengths in close proximity to the antennas as required by a conventional feed approach changes the behaviors of the radiating elements 308-1, 308-2 relative to each other, and thus typically introduces non-linear phase pattern differences and frequency shifts in the received representations of an incoming RF signal between the two antenna.

Accordingly, to reduce or eliminate this asymmetry in the feed structure and thus mitigate non-linear phase pattern differences and frequency shift, in at least one embodiment the feed structure 312 of the antenna array 300 is configured to provide symmetry with respect to the radiating elements 308-1, 308-2 by implementing microstrip feedlines 314-1, 314-2 that each connects to an additional feed point, and thus resulting in each feedline 314-1, 314-2 connecting to the feed probe 310 at one end and to two feed points at the other end. For example, in the illustrated embodiment of FIGS. 3 and 4, the microstrip feedline 314-1 connects at one end to the feed probe 310 through a conductive via 404 (FIG. 4) extending through a dielectric layer 406 (e.g., an epoxy resin) and connects at the other end to the feed points 341 and 342 of the radiating element 308-1 using conductive vias 408 and 410, respectively. Likewise, the microstrip feedline 314-2 connects at one end to the feed probe 310 through a conductive via 412 and connects at the other end to the feed points 341 and 342 of the radiating element 308-2 using conductive vias 414 and 416, respectively. Using this approach, the microstrip feedlines 314-1, 314-2 can have substantially equal lengths, and thereby providing the desired symmetry, and the use of a second feed point connection for each feedline also ensures that the current distribution remains substantially unchanged, and thus avoiding negative impact on the operation of each radiating element 308. Moreover, in the illustrated implementation in which the feed probe 310 is located between the two radiating elements 308-1, 308-2, the result is that the resulting received signal representations from radiating elements 308-1, 308-2 have a 180 degree phase difference, which can be readily calibrated and adjusted for by the receiver component utilizing the antenna array 300.

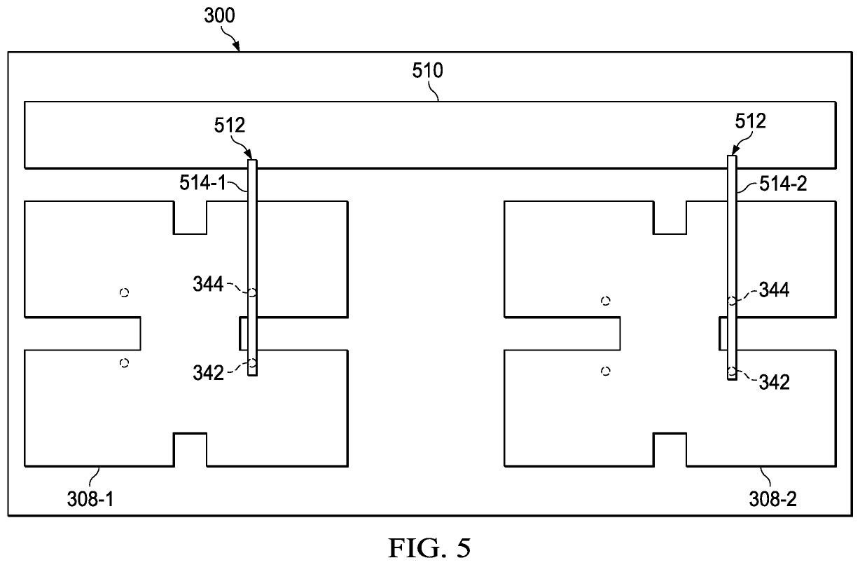

Although FIGS. 3 and 4 illustrate one example in which the microstrip feedlines 314-1, 314-2 connect to feed points 341, 342 in the corresponding radiating elements 308-1, 308-2, the microstrip feedlines 314-1, 314-2 instead could be shifted in the Y-direction and connect to feed points 343 and 344 on each radiating element 108. Moreover, so long as the same two corresponding feed points are used on each radiating element 308 and the lengths of the microstrip feed lines 314 are approximately equal and thus maintaining symmetry, rather than being disposed between the two radiating elements 308, the feed probe 310 can instead be disposed adjacent to corresponding outer edges of the radiating elements 308-1, 308-2 (that is, adjacent to edges of the radiating elements 308-1, 308-2 that are colinear). To illustrate, FIG. 5 illustrates an alternative embodiment of the antenna array 300 in which a feed probe 510 is disposed parallel to the “top” collinear edges of the radiating elements 308-1, 308-2 (“top” being relative to the view orientation of FIG. 5). A feed structure 512 includes microstrip feed lines 514-1 and 514-2. The microstrip feed line 514-1 connects to the feed probe 510 at one end and to the feed points 342 and 344 (by way of conductive vias) of the radiating element 308-1 at the second end. The microstrip feed line 514-2 likewise connects to the feed probe 510 at one end and to the feed points 342 and 344 of the radiating element 308-2 at the second end. In this approach, the microstrip feed lines 514-1 and 514-2 can have substantially equal lengths, and by virtue of these equal transmission line lengths and the dual feed point connections, the radiating elements 308-1, 308-2 in this configuration exhibit substantially similar responses and thus maintain substantially similar phase patterns and minimal or no frequency shifts.

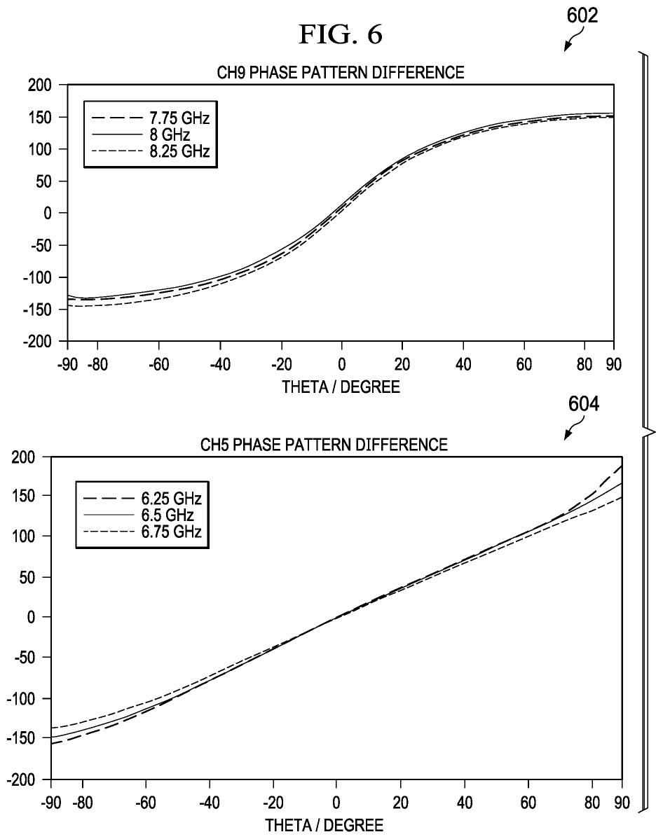

FIG. 6 illustrates charts depicting phase pattern differences exhibited by simulation of an example implementation of the antenna array 300 of FIGS. 3 and 4 in accordance with some embodiments. In this example, the antenna array 300 was simulated using the following relevant parameters:

TABLE 1
Simulation Parameters

| Parameter: | Value: |
|---|---|
| First Mode | UWB Channel 9 (8 GHZ, |
| | 500 MHZ bandwidth) |
| Second Mode | UWB Channel 5 (6.5 GHZ, |
| | 500 MHz bandwidth) |
| Substrate Material | LCP |
| Substrate Thickness | 0.4 mm (Z-direction) |
| Lateral Displacement (distance 316) | 15 mm center-to-center |
| Overall Length of Radiating Element | 10.1 mm |
| 308 in X-Direction (dimension 339) | |
| Overall Length of Radiating Element | 8.2 mm |
| 308 in Y-Direction (dimension 338) | |
| Slots 318, 320 Depth (dimension 334) | 1.05 mm |
| Slots 318, 320 Width (dimension 335) | 1.0 mm |
| Slots 322, 324 Depth (dimension 336) | 3.45 mm |
| Slots 322, 324 Width (dimension 337) | 1.0 mm |

Chart 602 illustrates the resulting phase pattern difference vs angle-of-arrival (θ) for the first mode (UWB Channel 9) and Chart 604 illustrates the phase pattern difference vs angle-of-arrival (θ) for the second mode (UWB Channel 5). As demonstrated, the angle-dependent phase pattern difference is substantially linear for both modes for angles-of-arrival (θ) between −60 degrees and +60 degrees across the entire 500 MHz bandwidth. Table 2 below sets forth additional salient operational behaviors obtained from the simulated implementation:

TABLE 2
Operational Behaviors

| Behavior | First Mode | Second Mode |
|---|---|---|
| Return Loss | >20 dB | >5 dB |
| Isolation | >20 dB | >20 dB |
| Radiation Efficiency | −3 dB | −6.7 dB |
| System Efficiency | −2.8 dB | −7.9 dB |
| 10 dB BW [MHz] | 650 | 1000 |

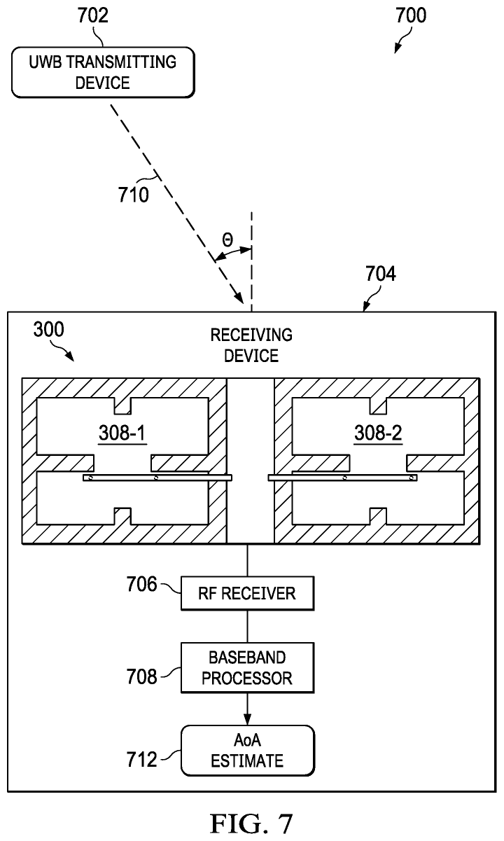

FIG. 7 illustrates a system 700 employing the dual-mode antenna array 300 for AoA calculations in accordance with some embodiments. The system 700 includes a transmitting device 702 and a receiving device 704 separated by a distance not greater than an effective range of the corresponding RF technology employed, which in the example embodiment is UWB-based RF signaling. The receiving device 704 represents any of a variety of compact electronic devices, such as a smartwatch, a cellular phone, a tablet computer, an RF subsystem of an automobile or other vehicle, an RF subsystem of a security system, and the like. The receiving device 704 includes the antenna array 300, an RF receiver 706 having an input electrically coupled to the feed probe 310 (FIG. 3) of the antenna array 300, and a baseband processor 708 having one or more inputs coupled to outputs of the RF receiver 706. The transmitting device 702 includes any of a variety of devices configured to transmit UWB signaling in one or more channels (e.g., Channel 5 and Channel 9) supported by the antenna array 300, such as a smartwatch, a cellular phone, a key fob, a tablet computer, and the like.

In operation, the transmitting device 702 transmits an incoming RF signal 710 that is received by the antenna array 300 of the receiving device 704 at an angle θ relative to the boresight of the antenna array 300. As such, this angle θ represents the AoA of the incoming RF signal 710 from the perspective of the receiving device 704. Because of this non-zero angle, there is a delay between when a representation of the RF signal 710 is received at the left antenna represented by the radiating element 308-1 and when a representation of the RF signal 710 is received at the right antenna represented by the radiating element 308-2, and thereby introducing a phase difference between the two received representations of the RF signal 710. Accordingly, the RF receiver 706 receives as input these two time-shifted/phase-shifted representations of the RF signal 710, performs any of a variety of pre-processing operations, such as various filtering operations, and provides an analog or digital representation of each received representation of the RF signal 710 to the baseband processor 708. The baseband processor 708 determines the phase difference between these two received representations, and based on the determined phase difference, determines one or more AoA estimates for the incoming RF signal 710. For example, in one embodiment the phase difference behavior of the antenna array 300 for a given mode can be quantified and used to populate a look-up table (LUT) having as inputs a phase difference and having as outputs corresponding AoA estimate values. An application processor (not shown) can then utilize the AoA estimate in conjunction with any ranging information obtained regarding the transmitting device from a separate ranging process to locate the transmitting device 702 relative to the receiving device 704.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A dual-mode antenna array configured to receive radio frequency (RF) signaling for angle-of-arrival (AoA) analysis, the antenna array comprising:
a substrate;
a ground plane disposed at a first side of the substrate; and
a pair of radiating elements disposed at a second side of the substrate opposite the first side and separated by a lateral distance, each radiating element of the pair comprising:
conductive material arranged in a modified rectangular shape having a first slot at a first side, a second slot at a second side opposite the first side, a third slot at a third side, and a fourth slot at a fourth side opposite the third side.

2. The dual-mode antenna array of claim 1, wherein:
the first slot and second slot each has a depth such that a length of a perimeter of the modified rectangular shape at each of the first side and the second side is at least equal to a half-wavelength of a center frequency of a first band in the received RF signaling; and/or
the third slot and fourth slot each has a depth such that a length of the perimeter of the modified rectangular shape at each of the third side and the fourth side is at least equal to a half-wavelength of a center frequency of a second band in the received RF signaling, the second band orthogonally polarized relative to the first band.

3. The dual-mode antenna array of claim 1, further comprising:
a feed probe disposed at the second side of the substrate and adjacent to the pair of radiating elements;
a first microstrip feedline conductively connected, at a first end, to the feed probe and connected, at a second end, to a first radiating element of the pair at each of a first feed point and a second feed point of the first radiating element; and/or
a second microstrip feedline conductively connected, at a first end, to the feed probe and conductively connected, at a second end, to a second radiating element of the pair at each of a third feed point and a fourth feed point of the second radiating element, the third and fourth feed points having locations on the second radiating element that correspond to locations of the first and second feed points, respectively, of the first radiating element.

4. The dual-mode antenna array of claim 3, wherein:
a length of the first microstrip feedline between the feed probe and the first feed point is substantially equal to a length of the second microstrip feedline between the feed probe and the third feed point; and/or
a length of the first microstrip feedline between the feed probe and the second feed point is substantially equal to a length of the second feedline between the feed probe and the fourth feed point.

5. The dual-mode antenna array of claim 3, wherein the first, second, third, and fourth feed points have substantially equal impedances.

6. The dual-mode antenna array of claim 3, wherein the feed probe is disposed between the first radiating element and the second radiating element.

7. The dual-mode antenna array of claim 3, wherein the feed probe is disposed adjacent to collinear sides of the first radiating element and the second radiating element.

8. The dual-mode antenna array of claim 3, wherein:
the first microstrip feedline is conductively coupled to the first feed point and second feed point using conductive vias; and/or
the second microstrip feedline is conductively coupled to the third feed point and fourth feed point using conductive vias.

9. The dual-mode antenna array of claim 2, wherein the lateral distance is not greater than half of the wavelength of the higher of the center frequency of the first band and the center frequency of the second band.

10. The dual-mode antenna array of claim 2, wherein:
a length of each of the first side and the second side is less than the wavelength of the center frequency of the first band in a material of the substrate; and/or
a length of each of the third side and the fourth side is less than the wavelength of the center frequency of the second band in a material of the substrate.

11. (canceled)

12. (canceled)

13. (canceled)

14. A dual-mode antenna array comprising:
a feed probe disposed at a first surface of a substrate;
first and second radiating elements disposed at the first surface of the substrate adjacent to the feed probe; and
a feed structure electrically coupling the first and second radiating elements to the feed probe, the feed structure comprising:
a first microstrip feedline connected to the feed probe at a first end and connected to first and second feed points of the first radiating element at a second end; and
a second microstrip feedline connected to the feed probe at a first end and connected to third and fourth feed points of the second radiating element at a second end; and
locations of the first and second feed points on the first radiating element being the same as locations of third and fourth feed points, respectively, on the second radiating element.

15. The dual-mode antenna array of claim 14, wherein the first microstrip feedline and the second microstrip feedline have substantially equal lengths.

16. The dual-mode antenna array of claim 14, wherein:
A length of the first microstrip feedline between the feed probe and the first feed point is substantially equal to a length of the second microstrip feedline between the feed probe and the third feed point; and/or
a length of the first microstrip feedline between the feed probe and the second feed point is substantially equal to a length of the second feedline between the feed probe and the fourth feed point.

17. The dual-mode antenna array of claim 14, wherein the first, second, third, and fourth feed points have substantially equal impedances.

18. The dual-mode antenna array of claim 14, wherein the feed probe is disposed between the first radiating element and the second radiating element.

19. The dual-mode antenna array of claim 14, wherein the feed probe is disposed adjacent to collinear sides of the first radiating element and the second radiating element.

20. The dual-mode antenna array of claim 14, wherein:
the first microstrip feedline is conductively coupled to the first feed point and second feed point using conductive vias; and/or
the second microstrip feedline is conductively coupled to the third feed point and fourth feed point using conductive vias.

21. (canceled)

22. An electronic device comprising the dual-mode antenna array of claim 14, and further comprising:
a radio frequency (RF) receiver conductively coupled to the feed probe and configured to process the RF signaling received at the dual-mode antenna array; and/or
a baseband processor coupled to the RF receiver and configured to determine one or more angle-of-analysis (AoA) parameters from the RF signaling received at the dual-mode antenna array and processed by the RF receiver.

23. A method of operating the electronic device of claim 22, comprising:
receiving a first representation of a first RF signal of the RF signaling at the first radiating element and receiving a second representation of the first RF signal of the RF signaling at the second radiating element; and
determining a first AoA parameter based on a phase difference between the first representation and the second representation of the first RF signal.

24. The method of claim 23, further comprising:
receiving a first representation of a second RF signal of the RF signaling at the first radiating element and receiving a second representation of the second RF signal of the RF signaling at the second radiating element; and
determining a second AoA parameter based on a phase difference between the first representation and the second representation of the second RF signal.
